(19) United States
(12) Patent Application Publication
(10) Pub. No.: US 2025/0055890 A1
(43) Pub. Date: Feb. 13, 2025

(54) Conferencing System Terminal Devices and Corresponding Methods for Prompting When Videoconferences End

(71) Applicant: Motorola Mobility LLC, Chicago, IL (US)

(72) Inventors: Amit Kumar Agrawal, Bangalore (IN); Vijayprakash Idlur, Karnataka (IN); Panduranga Reddy Pailla, Nalgonda (IN)

(21) Appl. No.: 18/231,523

(22) Filed: Aug. 8, 2023

(51) Int. Cl. H04L 65/403; G06F 40/289; G10L 15/08; G10L 15/22; G10L 25/78; H04L 65/1069

(52) U.S. Cl. CPC H04L 65/403; G06F 40/289; G10L 15/08; G10L 15/22; G10L 25/78; H04L 65/1069; G10L 2015/088

(57) ABSTRACT

A method in a conferencing system terminal device includes detecting, with one or more processors during a videoconference, a communication device electronically in communication with one or more remote electronic devices engaged in the videoconference. One or more processors identify that the videoconference is ending or has ended. The one or more processors determine that an application portal associated with the videoconference is still operational when the videoconference is ending or after the videoconference has ended. The one or more processors present, on a user interface of the conferencing system terminal device, a prompt indicating that the videoconference has ended or is ending when the application portal associated with the videoconference is still operational.

### BACKGROUND

### Technical Field

This disclosure relates generally to electronic devices, and more particularly to electronic devices capable of providing video conferencing features.

### Background Art

Many modern electronic devices, including smartphones, tablet computers, and laptop computers, are equipped to engage in videoconferences with other electronic devices across a network. Users employ such devices to communicate with friends, family, and work colleagues. This is especially true during times of pandemic, when people work remotely rather than going to a centralized office. Participants engage videoconferencing to engage in real-time discussions and share electronic content. Videoconferencing additionally offers participants the ability to see other participants via video feeds streamed to the participating electronic devices. It would be advantageous to have an improved methods, systems, and devices that make engagement with videoconferences easier and more efficient.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory conferencing system in accordance with one or more embodiments of the disclosure.

FIG. 2 illustrates a prior art method.

FIG. 3 illustrates one explanatory method in accordance with one or more embodiments of the disclosure.

FIG. 4 illustrates another explanatory method in accordance with one or more embodiments of the disclosure.

FIG. 5 illustrates one or more method steps in accordance with one or more embodiments of the disclosure.

FIG. 6 illustrates one explanatory conferencing system terminal device in accordance with one or more embodiments of the disclosure.

FIG. 7 illustrates one explanatory conferencing system server complex in accordance with one or more embodiments of the disclosure.

FIG. 8 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to presenting, by one or more processors on a user interface of a conferencing system terminal device, a prompt when a videoconference has ended, and an application portal associated with the videoconference is still operational. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of determining that a videoconference has ended while a videoconferencing application is operating on one or more processors of a conferencing system terminal device to present an application portal facilitating the videoconference on the user interface of the conferencing system terminal device and presenting a prompt indicating that the videoconference has ended while the videoconferencing application is operating on the one or more processors after the videoconference has ended as described herein. The non-processor circuits may include, but are not limited to, a radio receiver, a radio transmitter, signal drivers, clock circuits, power source circuits, and user input devices.

As such, these functions may be interpreted as steps of a method to perform presenting a prompt at a user interface of a conferencing system terminal device indicating that a videoconference has ended. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

In response to the COVID-19 pandemic, never before have employees worked remotely on such a massive scale. When millions of companies shifted to fully remote working conditions in a short period of time to slow the spread of the Coronavirus Disease 2019, videoconferencing became the logical solution for connecting the remote workforce and keeping teams productive from home. In a matter of weeks, video conferencing usage exploded, permeating nearly all aspects of professional and personal life. In addition to business-related meetings, remote teams around the globe began using video conferencing to host virtual happy hours, ice breaker activities, online games, wine tastings, birthday parties, and other social activities.

Despite the end of the pandemic, videoconference usage is still on the rise. Indeed, the videoconferencing market is expected to continue to grow at a nineteen percent compound annual growth rate through 2026. With the proliferation of the “work from home” lifestyle, for many videoconferencing has become the primary took for people to use when interacting with social peers, networking colleagues, work colleagues, friends, and family. Moreover, the proliferation of smart electronic devices with powerful processors, examples of which include smartphones, tablet computers, and laptop computers, have made it easier than ever to engage in videoconferences.

While videoconferences can be quite useful for staying in touch with friends, family, and colleagues, the mass adaptation and wide and frequent use of videoconferences can create problems. Illustrating by example, some people are engaging in so many videoconferences that it can become difficult to pay diligent attention to every videoconference at every moment. Said differently, it can be tough for the host of a videoconference to facilitate and maintain a high-level of user engagement throughout a videoconference. This is especially true when a videoconference lasts for an extended duration.

In some cases, videoconference attendees attempt to multitask while listening to videoconferences. For instance, rather than maintaining an application portal facilitating a videoconference front and center, a videoconference participant may minimize the application portal or hide it behind other application portals so that other work can be done. When working on a document, for example, the user may tile an application portal associated with a word processing application atop the application portal facilitating the videoconference, thereby rendering the application portal facilitating the videoconference partially or entirely not visible. In some situations, a user may cause an application portal unrelated to the videoconference to expand into an “immersive” mode, thereby completely blocking any access to content—audible or visible—from the application portal facilitating the videoconference. In other situations, a videoconference participant may just “zone out” and minimize the application portal facilitating the videoconference all together.

When any of these situations—or others—occur, the videoconference participant may not notice that a videoconference has ended. In addition to wasting computing resources, this failure to understand when a videoconference is ending can lead to awkward moments when everyone else leaves the videoconference except for the distracted participant not paying attention. Others may wonder, “what's up with that guy—he's still here and everyone else left?” Still others may come to realize that the participant was indeed not paying attention to the call. Instead, they may appear to have simply dialed in and left their conferencing system terminal device for the sake of making an appearance.

Things can become even more problematic when the videoconference is being recorded. Embodiments of the disclosure contemplate that many videoconferencing applications do not close or terminate operation so long as at least one participant is still logged into the videoconference application. Said differently. A videoconference facilitated by a videoconference application will continue going on as long as there is at least one participant in the call or unless it is closed by the organizer.

If a person is not paying attention, and a chat window is active and is being recorded, the “end” timestamp may not be entered into the chat window until the person finally realizes that the videoconference is over. If everyone but one person leaves the videoconference after thirty minutes, and the one person notices three hours later that the videoconference has ended, the chat would show a two and a half hour block of no activity followed by a conference end timestamp when that last person exits the videoconference. Anyone reviewing the chat window thereafter would know not only who wasn't paying attention but for how long they had been checked out as well. This could be damaging to the person's career. The damage would be compounded when the recording of the videoconference itself depicted proper content with participants speaking and sharing ideas for thirty minutes, followed by a recording of two and a half hours of one person's video feed being turned off with that person on mute. Anyone reviewing the recording would instantly understand that the checked out person never paid attention to the call.

Advantageously, embodiments of the disclosure provide a solution to this awkward scenario. In one or more embodiments, a method in a conferencing system terminal device comprises detecting, with one or more processors during a videoconference, a communication device electronically in communication with one or more remote electronic devices engaged in the videoconference. The one or more processors of the conferencing system terminal device can then determine that the videoconference has ended. In one or more embodiments, this determination of cessation of the videoconference occurs while an application portal associated with the videoconference is still operational after the videoconference has ended.

In one or more embodiments, when this occurs, the one or more processors present a prompt on a user interface of the conferencing system terminal device. In one or more embodiments, the prompt indicates that the videoconference has ended and is presented when both the videoconference has ended, and the application portal associated with the videoconference is still operational on the one or more processors. This allows a user who has checked out to be alerted to the videoconference end so as to be able to close the application portal associated with the videoconference. In one or more embodiments, when the prompt is presented before all other videoconference attendees have left, the prompt allows the checked-out participant to at least say goodbye to those participants who remain without looking like a total slacker.

In one or more embodiments, the one or more processors present the prompt when the application portal associated with the videoconference is operating as a background application while another application portal associated with another application is operating as a foreground application. Illustrating by example, if a person has tiled a word processing application portal atop a videoconference application portal, such that the word processing application portal is the foreground application portal and the videoconference application portal is the background application portal, the one or more processors can present the prompt when both the videoconference has ended, and the application portal associated with the videoconference is still operational. Since the participant not paying attention cannot see the application portal associated with the videoconference, the presentation of this prompt alerts them to the fact that the videoconference is ending.

In one or more embodiments, the prompt facilitates causing the application portal associated with the videoconference to again become the foreground application. Illustrating by example, in one or more embodiments the one or more processors can automatically return the application portal associated with the videoconference to again become the foreground application in addition to presenting the prompt.

The fact that the videoconference is ending, or has ended, can be determined in a variety of ways. Illustrating by example, in one or more embodiments the one or more processors identify that the videoconference has ended by detecting audio signals comprising phrases indicative of videoconference cessation. For instance, phrases indicative of videoconference cessation can include people saying things like “bye,” “thank you,” and/or “great call.” These are examples only as other phrases indicative of videoconference cessation will be obvious to those of ordinary skill in the art having the benefit of this disclosure.

In other situations, the one or more processors may detect the videoconference is ending or has ended from detecting text in a chat window. Embodiments of the disclosure contemplate that most videoconference applications today include integrated chat windows allowing parallel sharing of text and media files while a videoconference is occurring. Embodiments of the disclosure also contemplate that these chat windows can indicate—passively or directly—that a videoconference has ended. Accordingly, in one or more embodiments the one or more processors identify that the videoconference has ended by detecting text in a chat window of the application portal that either states that the videoconference has ended or that suggests the same by including phrases indicative of videoconference cessation.

In still other embodiments, the one or more processors can detect that the videoconference has ended simply by detecting the fact that nobody is talking. Said differently, in one or more embodiments the one or more processors identify the videoconference has ended by detecting an absence of audio signals from participants of the videoconference for at least a predefined duration.

In other embodiments, this lack of talking can be combined with scheduling information to determine that a videoconference has ended. In one or more embodiments, the one or more processors determine that the videoconference has ended by detecting the absence of the audio signals for at least the predefined duration after a scheduled adjournment of the videoconference has passed. Other ways for determining the videoconference has ended will be described below. Still others will be obvious to those of ordinary skill in the art having the benefit of this disclosure.

Since situations in which applications other than the videoconference application are operating in an immersive mode where they occupy all or substantially all of the display of a conferencing system terminal device and are the only applications generating audio emanating from the conferencing system terminal device, in one or more embodiments the prompt is presented when such an application is operating in such an immersive mode. Said differently, in one or more embodiments the one or more processors determine that the conferencing system terminal device is operating in an immersive mode of operation while the communication device is electronically in communication with the one or more remote electronic devices engaged in the videoconference. Thereafter, presentation of the prompt occurs only when the videoconference has ended, the application portal associated with the videoconference is still operational, and the conferencing system terminal device is operating in the immersive mode of operation.

Accordingly, in one or more embodiments a conferencing system terminal device comprises a communication device in communication with one or more embodiments remote electronic devices during a videoconference. The conferencing system terminal device also includes a user interface and one or more processors operable with the user interface and the communication device.

In one or more embodiments, the one or more processors determine that the videoconference has ended while a videoconferencing application is operating on the one or more processors to present an application portal facilitating the videoconference on the user interface. The one or more processors then present a prompt indicating that the videoconference has ended while the videoconference application is operating on the one or more processors after the videoconference has ended.

In one or more embodiments, the prompt is visibly presented on a display so it can be seen. In other embodiments, the prompt comprises an audible prompt aurally alerting a user to the fact that the videoconference has ended. Of course, combinations of visible and audible prompts can be used as well.

In one or more embodiments, a method in a conferencing system terminal device comprises detecting, with one or more processors during a videoconference, a communication device electronically in communication with one or more remote electronic devices engaged in the videoconference while an application portal facilitating the videoconference is operating as a background application and another application portal that is different from the application portal facilitating the videoconference is operating in an immersive mode of operation as a foreground application. The one or more processors then identify that the videoconference has ended and present a prompt at the user interface indicating the same. In one or more embodiments, the prompt facilitates return of the application portal facilitating the videoconference to operating as the foreground application. In one or more embodiments the presentation of the prompt occurs only when the application portal facilitating the videoconference is still operational after the videoconference has ended.

Advantageously, embodiments of the disclosure prompt a user who has checked out from a videoconference or is otherwise not paying attention to alert them to the fact that the videoconference has ended. This helps to prevent those awkward moments where a user's conferencing system terminal device remains connected to the videoconference despite the same having ended. This advantageously presents embarrassment and ridicule, as well as conserving computational resources. Other advantages offered by embodiments of the disclosure will be described below. Still others will be obvious to those of ordinary skill in the art having the benefit of this disclosure.

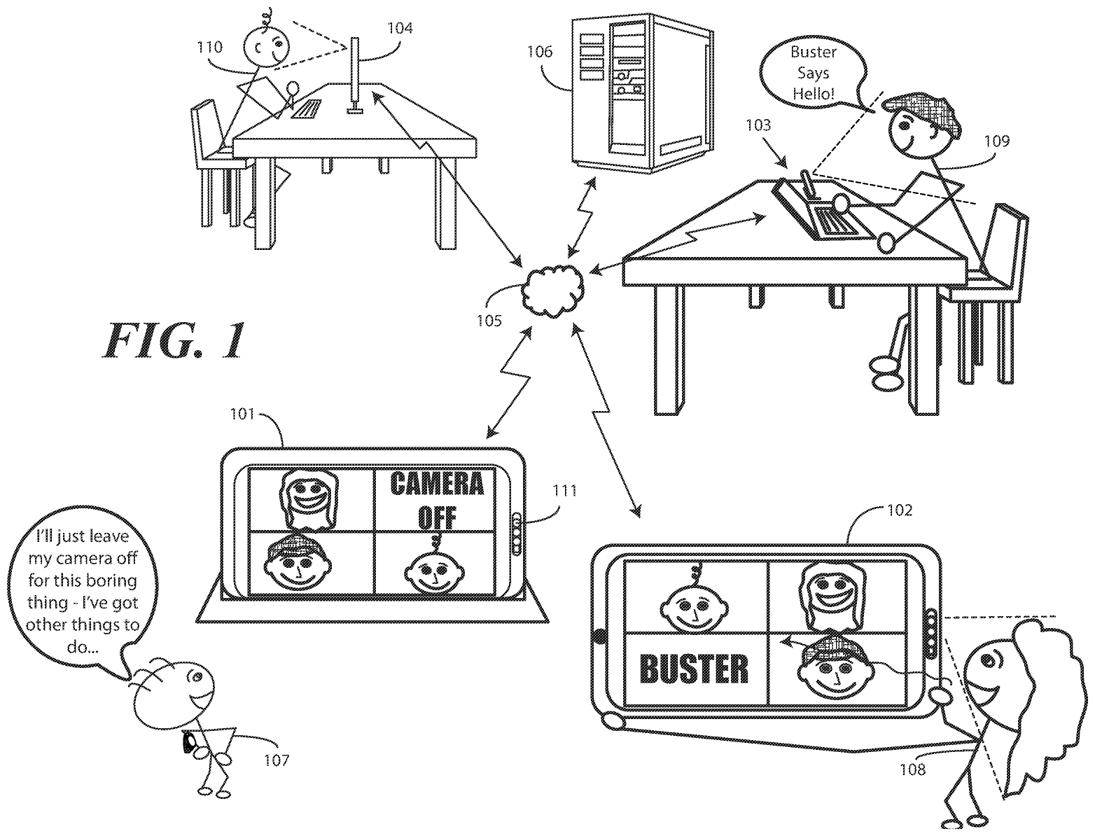

Turning now to FIG. 1, illustrated therein is one explanatory videoconference system in accordance with one or more embodiments of the disclosure. As shown, multiple participants 107,108,109,110 each employ their own respective conferencing system terminal device 101,102,103,104 to engage with the other participants via the videoconference. In this illustrative embodiment, conferencing system terminal devices 101,102 are shown as smartphones, while conferencing system terminal devices 103,104 are shown as desktop computers, with conferencing system terminal device 103 using a companion smartphone as a camera.

In other embodiments, conferencing system terminal devices suitable for use in the videoconference system can take other forms. For instance, tablet computers, notebook computers, audiovisual devices, mobile phones, smart watches, or other devices can be used by participants to engage in the videoconference as well. Other examples of conferencing system terminal devices will be obvious to those of ordinary skill in the art having the benefit of this disclosure.

As shown in FIG. 1, each conferencing system terminal device 101,102,103,104 is engaged in wired or wireless communication with each other across a network 105, one example of which is the Internet via the World Wide Web. It should be noted that the network 105 could be a public, private, local area, wide area, or other type of network across which wired or wireless electronic communications can be exchanged.

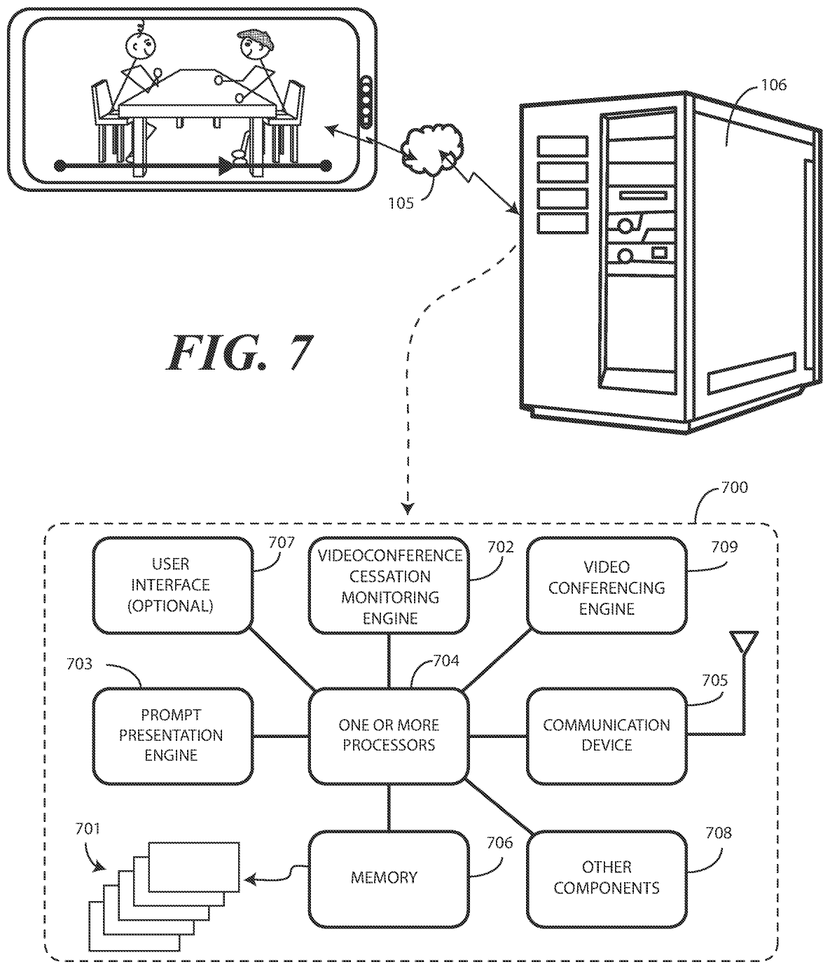

In this illustrative embodiment, each conferencing system terminal device 101,102,103,104 is also in communication with a video conferencing system server complex 106 across the network 105. As will be described in more detail with reference to FIG. 7 below, in one or more embodiments video conferencing system server complex 106 includes components such as a web server, a database server, an audio server, and optionally a video server (the video server may be omitted for audio only conferencing systems) that are operable to facilitate videoconferences between the various conferencing system terminal devices 101,102,103,104 of the videoconference system.

These components of the video conferencing system server complex 106 can be combined on the same server. Alternatively, these components can be distributed on any number of servers to increase load handling capacity beyond that of a single server, and so forth. Other configurations for the video conferencing system server complex 106 will be obvious to those of ordinary skill in the art having the benefit of this disclosure.

In one or more embodiments, the video conferencing system server complex 106 performs functions such as maintaining a schedule of videoconferences, maintaining lists of participants, as well as allowing each participant's conferencing system terminal device to engage with the videoconference, and so forth. In one or more embodiments, the video conferencing system server complex 106 also facilitates the transmission of audio and video content during the occurrence of the videoconference.

In one or more embodiments, the video conferencing system server complex 106 functions as an intermediary device to facilitate sharing of audio and/or video content and/or data between the various conferencing system terminal devices 101,102,103,104. For example, as can be seen on the displays of conferencing system terminal devices 101,102, in this example each participant 107,108,109,110 can see each other participant engaged in the videoconference.

In the illustrative example of FIG. 1, the participants 107,108,109,110 are engaged in the videoconference. Since the participants 107,108,109,110 are all engaged in a videoconference, each can see conference content in the form of a combined video feed from each other participant 107,108,109,110 presented on the display of each conferencing system terminal device 101,102,103,104, as well as a video feed of themselves. Under ordinary conditions, each participant 107,108,109,110 can hear an audio feed from each other participant 107,108,109,110 as well.

In this illustrative embodiment, participant 109 is acting as a presenter, and is speaking, noting that a friend, Buster, “says hello.” The presenter's conferencing system terminal device 103 receives this audio and captures video of the presenter and transmits the same to the other conferencing system terminal devices 101,102,103 via the video conferencing system server complex 106. While participant 110 is the presenter at the moment, it is to be understood that the presenter role can be changed throughout the videoconference as well, with each other participant 107,108,110 taking the role of presenter at other times as situations warrant.

Participant 107 has other things to do during this videoconference. However, he does not want the others to know this. He instead wants them to think he is fully engaged in the videoconference.

Accordingly, to allow participant 107 to do other things, he has disabled his camera 111. This will prevent the other participants 108,109,110 from seeing him leave the field of view of the camera 111 to do other things like watching television and cooking.

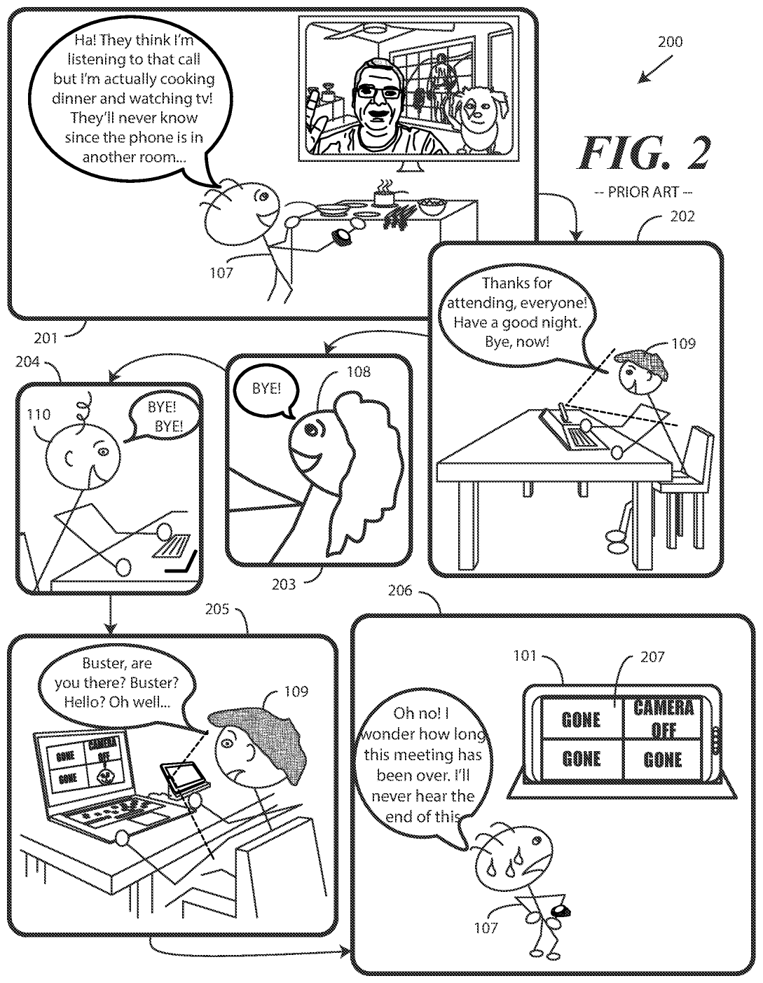

Turning now to FIG. 2, illustrates therein is a prior art method 200 illustrating what can occur when participant 107 completely checks out of the videoconference of FIG. 1. As shown at step 201, participant 107 has completely left the room where his conferencing system terminal device 101 was docked and is instead cooking and watching his favorite show featuring the shenanigans of Amit and his trusty dog. Participant 107 revels in his ability to check out of the videoconference and instead engage in leisure activities, stating, “They think I'm listening to that call but I'm actually cooking dinner and watching tv!” Since the camera (111) of the conferencing system terminal device 101 is off and the microphone is muted, the other participants 108,109,110 engaged in the videoconference do not hear or see this revelry. Instead, they believe participant 107 to be actively engaged in the videoconference.

At step 202, participant 109 begins to end the meeting. In doing so, participant 109 utters phrases indicative of videoconference cessation. Examples of such phrases indicative of videoconference cessation include “bye,” “thank you,” and/or “great call.” Here, participant 109 states, “Thanks for attending, everyone! Have a good night. Bye, now!”

At step 203, participant 108 responds with another phrase indicative of videoconference cessation by saying “bye.” Participant 110 does the same at step 204, saying, “Bye! Bye!”

Participant 107 has no idea that this is occurring due to his engagement in other activities. Before signing out of the videoconference, participant 109 notices that participant 107 has not provided the courtesy of a return phrase indicative of videoconference cessation. Instead, the window corresponding to participant 107 appears exactly the same as it did during the videoconference, as shown at step 205. This indicates either participant 107 has completely checked out and is paying no attention to the videoconference whatsoever, or that something bad has happened to participant 107 rendering him unable to pay attention to the videoconference. Becoming worried, participant 109 asks, “Buster, are you there?Buster?” Feeling completely insulted by being ignored during the videoconference, participant 109 exits the videoconference.

Thereafter, at step 206, participant 107 returns to the room where his conferencing system terminal device 101 is docked. As shown, the application portal 207 facilitating the videoconference is still operational on the conferencing system terminal device 101. However, the videoconference has ended, and all other participants have left. Seeing that this is the case, participant 107 feels terrible and wonders if everyone thinks he's injured, asleep, or just rude.

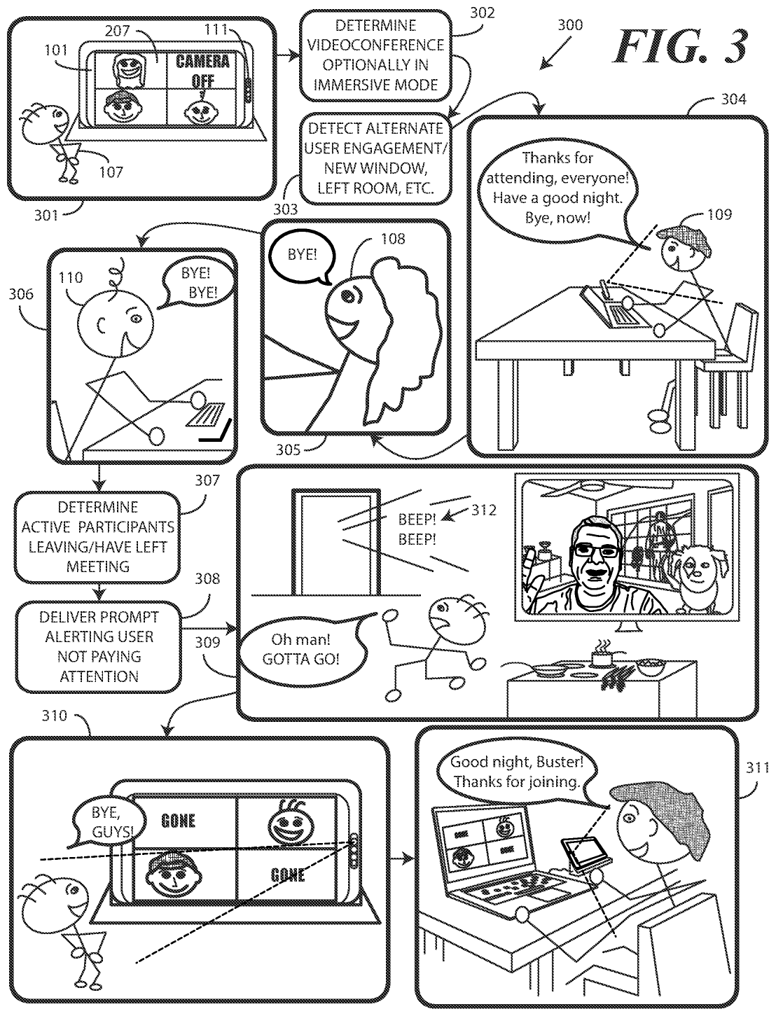

Advantageously, embodiments of the disclosure prevent this problem from happening. Embodiments do this by determining that a videoconference has ended and that an application portal associated with the videoconference is still operational after the videoconference has ended. In one or more embodiments, one or more processors of a conferencing system terminal device then present a prompt indicating that the videoconference has ended when both the videoconference is over, and the application portal associated with the videoconference is still operational. Turning now to FIG. 3, illustrated therein is one explanatory method 300 in accordance with one or more embodiments of the disclosure.

Beginning at step 301, participant 107 is engaged in the videoconference. Accordingly, one or more processors of the conferencing system terminal device 101 detect, using a communication device of the conferencing system terminal device 101, that the communication device is in communication with one or more remote electronic devices engaged in the videoconference. Continuing the example from FIG. 1, the other remote electronic devices would be conferencing system terminal devices (102,103,104).

As shown at step 301, an application portal 207 facilitating the videoconference is operating as a foreground application on the one or more processors of the conferencing system terminal device 101. When operating as the foreground application, the application portal 207 is visible on the display of the conferencing system terminal device 101. Additionally, audio from the application portal 207 is emanating from the audio output devices of the conferencing system terminal device 101.

In this illustrative embodiment, the application portal 207 is operating in an immersive mode as the foreground application on the one or more processors of the conferencing system terminal device 101. In one or more embodiments, this means that the application portal 207 consumes all, or substantially all, of the display of the conferencing system terminal device 101. In some embodiments, this means that the audio signals from the application portal 207 are the only ones being delivered by the audio output devices of the conferencing system terminal device 101.

When operating in the immersive mode as the foreground application, the application portal 207 is the only one that can be seen and relegates all other application portals operating on the one or more processors of the conferencing system terminal device 101 to operating as background applications. Said differently, when the application portal 207 is operating in the immersive mode as the foreground application, the background applications are not accessible without causing the application portal 207 to exit the immersive mode in one or more embodiments. At optional step 302, one or more processors of the conferencing system terminal device 101 detect that the videoconference is occurring while the application portal 207 facilitating the videoconference is operating in the immersive mode.

At optional step 303, one or more processors of the conferencing system terminal device 101, using one or more sensors of the conferencing system terminal device 101, can detect an alternate user engagement, i.e., when participant 107 starts engaging in activities other than paying attention to the videoconference or interacting with the application portal 207. Illustrating by example, the camera 111 of the conferencing system terminal device 101 may detect that participant 107 has left the room by determining that participant 107 is no longer within the field of view of the camera 111. Similarly, a microphone can detect that participant 107 is not saying anything or is not responding to the other participants 108,109,110. In other embodiments, the one or more processors of the conferencing system terminal device may detect that the application portal 207 facilitating the videoconference is no longer the foreground application, but instead has been relegated to operating as a background application with another application that is different from the application facilitating the videoconference, presenting another application portal as the foreground application. Other techniques for determining that participant 107 is no longer engaged in the videoconference will be obvious to those of ordinary skill in the art having the benefit of this disclosure.

In this illustrative example, step 303 detects that participant 107 has left the room by using the camera 111 to detect that participant 107 is no longer within the field of view. This occurs at step 303 because, once again, participant 107 has completely left the room where his conferencing system terminal device 101 was docked and is instead cooking and watching the shenanigans of Amit and his trusty dog. Since transmissions from the camera 111 of the conferencing system terminal device 101 to the other electronic devices are being prevented and the microphone is muted, the other participants 108,109,110 engaged in the videoconference do not hear or see this revelry. Instead, they believe participant 107 to be actively engaged in the videoconference.

At step 304, participant 109 once again begins to end the meeting. In doing so, participant 109 utters phrases indicative of videoconference cessation, examples of which include “bye,” “thank you,” and/or “great call.” Here, participant 109 states, “Thanks for attending, everyone! Have a good night. Bye, now!”

At step 305, participant 108 responds with another phrase indicative of videoconference cessation by saying “bye.” Participant 110 does the same at step 306, saying, “Bye! Bye!”

At step 307, one or more processors of conferencing system terminal device 101 identify that the videoconference is has ended. In this illustrative embodiment, the one or more processors accomplish this by using one or more sensors of the conferencing system terminal device 101 to detect audio signals comprising the phrases indicative of videoconference cessation spoken by participants 108,109,110. In this illustrative embodiment, the one or more processors of conferencing system terminal device 101 do this while the application portal 207 associated with the videoconference is still operational.

At step 308, the one or more processors of the conferencing system terminal device 101 present a prompt using a user interface of the conferencing system terminal device 101. While in many embodiments the prompt will be a visual prompt presented on the display of the conferencing system terminal device, in this example, as illustrated at step 309, the prompt 312 comprises and audible prompt that makes a loud beeping noise.

Participant 107, now understanding that the videoconference has ended. Quickly, he dashes back to the room where the conferencing system terminal device 101 is situated. As shown at step 310, he has arrived before participant 109 has closed his application portal facilitating the videoconference. Participant 107 is therefore able to turn the camera 111 of the conferencing system terminal device 101 on to say good-bye to participant 109. As shown at step 311, this makes participant 109 feel just fantastic.

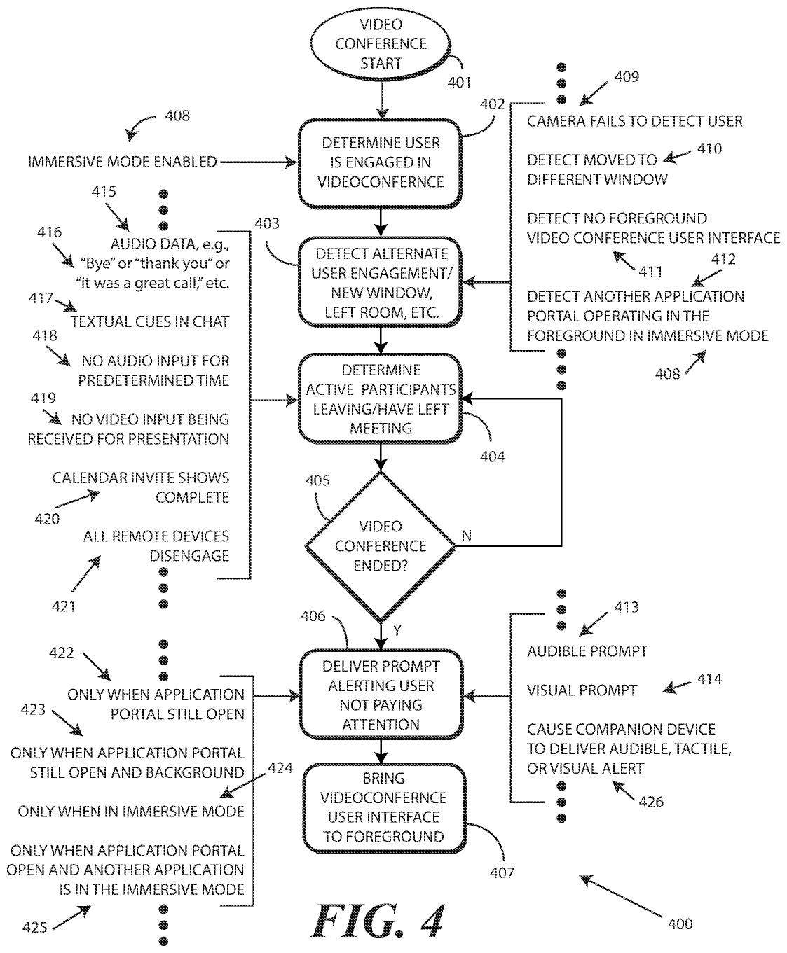

Turning now to FIG. 4, illustrated therein is another explanatory method 400 in accordance with one or more embodiments of the disclosure. The method 400 of FIG. 4 is more generalized than was the method (300) of FIG. 3, and therefore covers fact patterns in addition to those shown in the illustrative situations described with reference to FIG. 3.

Beginning at stage 401, a videoconference commences with one or more conferencing system terminal devices engaged in the videoconference. At step 402, one or more processors of a conferencing system terminal device engaged in the videoconference determine that a communication device of the conferencing system terminal device is in communication with one or more remote electronic devices during the videoconference that started at stage 401. In one or more embodiments, step 402 comprises the one or more processors detecting, during the videoconference, the communication device of the conferencing system terminal device is electronically in communication with the one or more remote electronic devices engaged in the videoconference while an application portal of an application operating on the one or more processors and facilitating the videoconference is operating in an immersive mode 408 of operation.

At step 403, one or more processors of the conferencing system terminal device determine that a user is engaged in an alternate activity that is something other than engaging with the application portal facilitating the videoconference. As noted above, this can be done in a variety of ways.

In one or more embodiments, step 403 comprises a camera 409 of the conferencing system terminal device failing to detect the user being within the field of view of the camera 409. If, for instance, the videoconference participant leaves the room to cook and watch television, as was the case in FIG. 3 above, in one or more embodiments the camera 409 can detect this by failing to capture images of the participant. This can indicate that the user is no longer adjacent to the conferencing system terminal device and may not be looking at the display where the application portal facilitating the videoconference is being presented.

In another embodiment, the one or more processors of the conferencing system terminal device can detect the user engaging an application portal 410 of an application that is different from the application portal facilitating the videoconference. Illustrating by example, the user may start typing in a word processing application portal while working on a document. In one or more embodiments, the one or more processors of the conferencing system terminal device conclude at step 403 that the user is no longer engaged in the application portal facilitating the videoconference.

In other embodiments, step 403 can comprise the one or more processors of the conferencing system terminal device detecting an absence 411 of any application portal facilitating the videoconference appearing on the user interface. This may occur, for example, if a user minimizes the application portal facilitating the videoconference to keep it running without having to see its visual output or hear its audio output.

In still other embodiments, step 403 can comprise the one or more processors of the conferencing system terminal device detecting, during the videoconference, that the communication device of the conferencing system terminal device is electronically in communication with the other devices engaged in the videoconference while the application portal facilitating the videoconference has been relegated to operating as a background application. Illustrating by example, the user may tile another application portal 412 that is different from the application portal facilitating the videoconference is operating as a foreground application, and optionally in the immersive mode 408 of operation, with the application portal facilitating the videoconference operating as a background application.

If, for example, the user tiles the word processing application portal atop the application portal facilitating the videoconference while working on the document, this can bring the application portal of the word processing application to operate as the foreground application while the application portal facilitating the videoconference operates as the background application. In one or more embodiments, this detection is made when the application portal operating 412 as the foreground application is operating in an immersive mode 408 while the application portal facilitating the videoconference operates as the background application.

These examples of detecting alternate engagements of a user described with reference to step 403 are illustrative only. Numerous other will be obvious to those of ordinary skill in the art having the benefit of this disclosure.

At step 404, the one or more processors of the conferencing system terminal device determine that the videoconference are leaving or have left the videoconference. As with the determination that the participant is engaged in an alternate activity that is something other than engaging with the application portal facilitating the videoconference, the determination that the videoconference is ending or has ended can occur in a variety of ways.

In one or more embodiments, step 404 detecting audio signals 415 comprising phrases 416 indicative of videoconference cessation. Examples of such phrases 416 indicative of the videoconference cessation comprise one or more of “bye,” “thank you,” and/or “great call.” Other examples of phrases 416 indicative of videoconference cessation will be obvious to those of ordinary skill in the art having the benefit of this disclosure.

In other embodiments, step 404 can include identifying that the videoconference is ending or has ended by detecting text 417 in a chat window of the application portal facilitating the videoconference. Embodiments of the disclosure contemplate that these days most applications facilitating videoconferences are configured with integrated chat windows. Participants in videoconferences can use these integrated chat windows to engage in parallel sharing of text and media files while the videoconference is occurring. Moreover, in many cases these chat windows indicate meeting start and end times.

Accordingly, in one or more embodiments one or more processors of a conferencing system terminal device can monitor the chat window for contextual cues that the videoconference may be ending or has ended. These textual cues can be comments from the participants comprising phrases 416 indicative of videoconference cessation such as “bye,” “thank you,” and/or great call. Alternatively, the textual cues can be generated by the application facilitating the videoconference, examples of which include “meeting has ended,” “this videoconference is over,” and/or “end of meeting” or “end of videoconference.”

In still other embodiments, step 404 can comprise identifying that a videoconference has ended or is ending by detecting an absence of audio signals 418 from participants of the videoconference for at least a predefined duration. If no one says anything for a predefined duration such as three minutes, five minutes, or ten minutes, in one or more embodiments one or more processors of the conferencing system terminal device use this as a contextual cue that the videoconference has ended. An absence of video signals 419 can be used in a similar manner.

In other embodiments, step 404 can comprise extracting a videoconference cessation time from a calendar invitation 420 associated with the videoconference. Since many conferencing system terminal devices will operate calendaring applications in addition to videoconference applications that facilitate the videoconference, in some embodiments one or more processors of the conferencing system terminal device can extract the completion time for the videoconference from a calendar invitation 420 inviting the participant to the videoconference itself.

Of course, a combination of an absence of audio signals 418 and/or an absence of video signals 419 with a meeting cessation determined from any of the other factors mentioned above can be used as well. Illustrating by example, in one or more embodiments step 404 comprises identifying that a videoconference has ended or is ending by detecting that the absence of the audio signals 418 from participants of the videoconference for the at least a predefined duration occurs after a scheduled adjournment time of the videoconference taken from the calendar invitation 420, and so forth. In one or more embodiments, step 404 can comprise identifying that a videoconference has ended or is ending by determining that all other remote electronic devices engaged with the videoconference disengage 421 from the videoconference.

In some embodiments, step 404 can comprise identifying that a videoconference has ended or is ending by determining that a videoconference window associated with the application portal facilitating the videoconference has closed. However, in other embodiments, the one or more processors of the conferencing system terminal device will determine that the videoconference has ended or is ending while the application portal associated with the videoconference has ended.

In any event, decision 405 determines whether the videoconference has ended. Where it has, step 406 comprises presenting a prompt indicating that the videoconference has ended using a user interface of the conferencing system terminal device. In one or more embodiments, the prompt presented at step 406 is an audible prompt 413, one example of which was the loud beeping described above with reference to FIG. 3. In other embodiments, the prompt presented is a visual prompt 414 presented on a display of the user interface. Of course, these prompts could be used in combination. Additionally, tactile feedback 426 or other attention getting outputs of the conferencing system terminal device could be delivered with the prompt as well.

In many embodiments, the presentation of the prompt occurs at step 406 anytime the one or more processors of the conferencing system terminal device determine that the videoconference is ending or has ended. However, in other embodiments the presentation of the prompt at step 406 is conditional. Illustrating by example, in one or more embodiments the prompt is presented at step 406 only when both the videoconference has ended, as determined by decision 405, and when the application portal 422 associated with the videoconference is still operational. Embodiments of the disclosure contemplate that if the application portal automatically closes or the application facilitating the videoconference terminates when the videoconference ends, it may be unnecessary to present a prompt. However, when the application portal facilitating the videoconference remains open, the presentation of a prompt is advantageous. Accordingly, in one or more embodiments when the one or more processors of the conferencing system terminal device determine that the videoconference has ended while a videoconferencing application is operating on the one or more processors to present an application portal 422 facilitating the videoconference on the user interface, step 406 comprises presenting a prompt indicating that the videoconference has ended while the videoconferencing application is operating on the one or more processors after the videoconference has ended.

In other embodiments, the presentation of the prompt at step 406 occurs only when the videoconference has ended, as determined by decision 405, and the application portal 422 facilitating the videoconference is still operational, but where the application portal 422 facilitating the videoconference is operating as a background application 423 while another application portal associated with another application is operating as the foreground application. Said differently, in one or more embodiments step 406 comprises the one or more processors presenting the prompt indicating that the videoconference has ended only when another application portal that is different from the application portal facilitating the videoconference is operating as a foreground application.

Embodiments of the disclosure contemplate that this conditional mode of operation can be beneficial when a person is working on another application, playing games in another application, or performing other tasks in another application when the videoconference ends. Since the application portal 422 facilitating the videoconference is operating as a background application, the participant may not be aware of the videoconference ending. This is especially true when the application other than the videoconference application is operating in an immersive mode. Accordingly, in some embodiments the presentation of the prompt at step 406 occurs only when the videoconference has ended, as determined by decision 405, the application portal 422 associated with the videoconference is still operational, and the conferencing system terminal device is operating in the immersive mode of operation 424. In still other embodiments, step 406 comprises presenting the prompt at the user interface of the conferencing system terminal device when the application portal 422 facilitating the videoconference is operating as a background application 423 while another application portal that is different from the application portal 422 facilitating the videoconference is operating in an immersive mode 425 as a foreground application.

In one or more embodiments, the prompt presented at step 406 facilitates causing the application portal 422 associated with, or facilitating, the videoconference to again become the foreground application. In some embodiments, this causing the return of the application portal 422 associated with the videoconference to the foreground is automatic. Illustrating by example, in one or more embodiments step 407 comprises automatically returning, by the one or more processors, the application portal 422 associated with the videoconference to again become the foreground application in addition to the presenting the prompt at step 406. In other embodiments, step 407 comprises causing the application portal 422 facilitating the videoconference to become the foreground application concurrently with the presentation of the prompt at step 406.

In still other embodiments, the prompt presented at step 406 can comprise a user actuation target that, when actuated, causes the application portal 422 facilitating the videoconference to again become the foreground application. Accordingly, in one or more embodiments the return of the application portal 422 facilitating the videoconference to operation in the foreground occurs in response to actuation of a user actuation target included with the prompt presented at step 406.

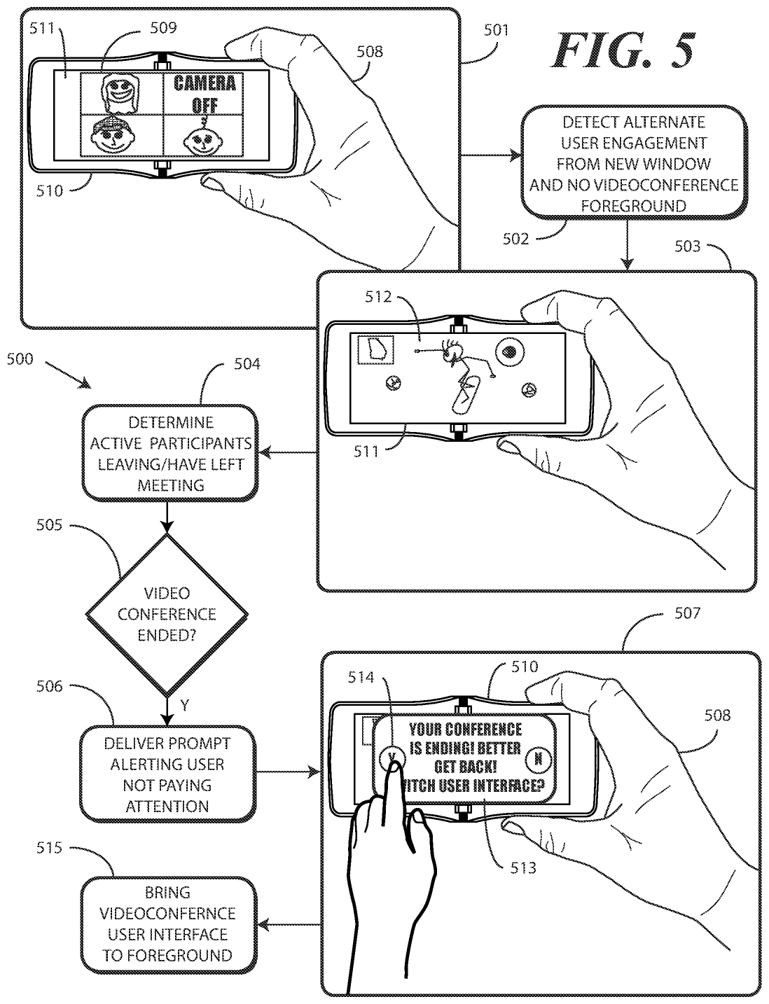

Now that the general method has been explained, another fact specific example will be provided for illustration purposes to better explain advantages offered by embodiments of the disclosure. Turning now to FIG. 5, illustrated therein is one such explanatory method 500.

Beginning at step 501, a user 508 is using a conferencing system terminal device 510 to engage in a videoconference. As shown, an application portal 509 facilitating the videoconference is operating as a foreground application, with the application portal 509 being presented on a display 511 of the conferencing system terminal device 510.

At step 502, one or more processors of the conferencing system terminal device 510 determine that the user 508 has checked out of the videoconference and is instead doing something else. While any of the techniques described above with reference to the method (400) of FIG. 4 could be used, in this illustrative example the one or more processors detect another application portal 512, shown at step 503, operating as a foreground application while the application portal 509 facilitating the videoconference is relegated to operating as a background application. In this illustration, the other application portal 512 is a gaming application facilitating a snowboarding game. As shown at step 503, the other application portal 512 is operating in an immersive mode of operation, with the application portal 512 filling the entire display 511.

At step 504, the one or more processors of the conferencing system terminal device 510 determine that the videoconference is ending. While any of the techniques described above with reference to the method (400) of FIG. 4 could be used, in this illustrative example the one or more processors determine that the videoconference has ended by identifying that all of the other remote electronic devices engaged in the videoconference have left the videoconference. Step 504 can begin making this determination when the first remote electronic device leaves, with a confirmation that the videoconference has ended being made at decision 505 when the last remote electronic device leaves the videoconference.

At step 506, the one or more processors of the conferencing system terminal device 510 present a prompt 513, shown at step 507, indicating that the videoconference has ended. In this illustrative embodiment, the prompt 513 facilitates return of the application portal 509 facilitating the videoconference to operating as the foreground application. While this return could be automatic as described above, in this illustrative example the prompt 513 comprises a user actuation target 514 that, when actuated, causes the application portal 509 facilitating the videoconference to again return to operating as the foreground application. As shown at step 507, the user 508 is actuating the user actuation target 514. Accordingly, at step 515 the one or more processors of the conferencing system terminal device 510 cause the application portal 509 facilitating the videoconference to return to operation as the foreground application.

Advantageously, despite the fact that the user 508 could not see the application portal 509 facilitating the videoconference while the snowboarding game was operating in the immersive mode, the prompt 513 allows the user 508 to quickly cause the application portal 509 facilitating the videoconference to return to operating as the foreground application. It should be noted that decision 505 is optional. Accordingly, the prompt 513 can be presented when the videoconference is ending, e.g., when a predefined number of remote electronic devices engaged in the videoconference, but not all, have left the videoconference as shown at step 507. This allows the user 508 to say goodbye to at least one participant as was the case in the example of FIG. 3 above. In other embodiments, the prompt 513 is not presented until the videoconference has completely ended, as determined by optional decision 505.

Thus, as illustrated and described the method 500 of FIG. 5 determines, in an electronic device, that a participant of a videoconference operation is in an immersive mode of operation. In such an immersive mode, the participant has moved to a different window application and there is no videoconference related user interface active on the foreground of the conferencing system terminal device's display.

In one or more embodiments, one or more processors of the conferencing system terminal device determine that all active participants of the videoconference have left the videoconference. This determination can be made contextually in one or more embodiments, leveraging device sensors. Illustrating by example, audio data captured by a microphone of the conferencing system terminal device can detect phrases indicative of videoconference cessation such as “bye, bye,” “thank you all,” “it was a great meeting,” and so forth. Textual cues in chat windows with similar messaging, such as “bye” or “thank you,” can be used in a similar manner. In other embodiments, when no audio input is received for a threshold duration for any of the participants of the videoconference around the scheduled ending time for the videoconference, the one or more processors can also conclude that the videoconference has ended.

In one or more embodiments, the one or more processors of the conferencing system terminal device present a prompt on the display of the conferencing system terminal device responsive to the determination that the videoconference has ended while the application portal is still operational. In one or more embodiments, the prompt causes the videoconference application portal to again return to the main foreground so that the participant can close out the same.

The presentation of the prompt can be automatic or can be conditional. Indeed, as described above, in one or more embodiments a prompt is presented only when the videoconference has ended, and the application portal associated with the videoconference is still operational. In other embodiments, the prompt is presented only when the videoconference has ended, the application portal with the videoconference is still operational, and the application portal associated with the videoconference is operating as a background application while another application different from the application facilitating the videoconference is operating as the foreground application.

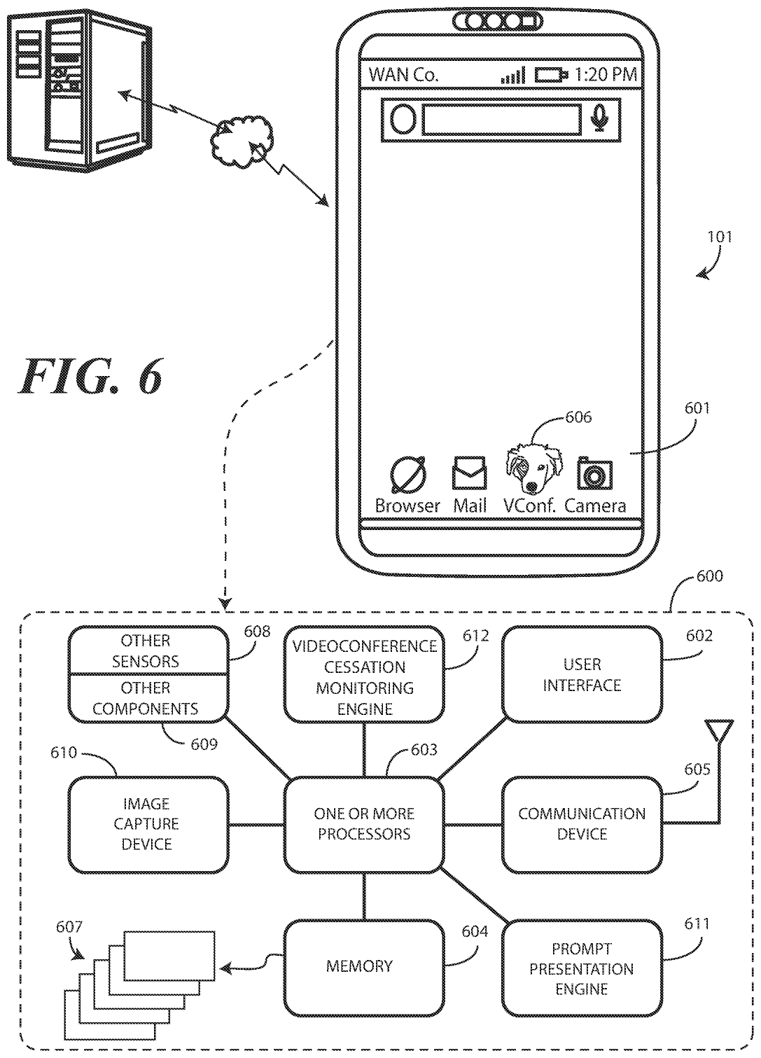

Turning now to FIG. 6, illustrated therein is one explanatory conferencing system terminal device 101 configured in accordance with one or more embodiments of the disclosure. The conferencing system terminal device 101 of FIG. 6 is a portable electronic device. For illustrative purposes, the conferencing system terminal device 101 is shown as a smartphone. However, the conferencing system terminal device 101 could be any number of other devices as well, including tablet computers, desktop computers, notebook computers, and so forth. Still other types of conferencing system terminal devices can be configured in accordance with one or more embodiments of the disclosure as will be readily appreciated by those of ordinary skill in the art having the benefit of this disclosure.

This illustrative conferencing system terminal device 101 includes a display 601, which may optionally be touch-sensitive. In one embodiment where the display 601 is touch-sensitive, the display 601 can serve as a primary user interface 602 of the conferencing system terminal device 101. Users can deliver user input to the display 601 of such an embodiment by delivering touch input from a finger, stylus, or other objects disposed proximately with the display 601.

In one embodiment, the display 601 is configured as an active-matrix organic light emitting diode (AMOLED) display. However, it should be noted that other types of displays, including liquid crystal displays, would be obvious to those of ordinary skill in the art having the benefit of this disclosure. Where the conferencing system terminal device 101 is configured with a keyboard and/or mouse, such as when the conferencing system terminal device 101 is configured as a computer, the keyboard and/or mouse can serve as the primary user interface 602.

A block diagram schematic 600 of the conferencing system terminal device 101 is also shown in FIG. 6. The block diagram schematic 600 can be configured as a printed circuit board assembly disposed within the device housing of the conferencing system terminal device 101. Various components can be electrically coupled together by conductors, or a bus disposed along one or more printed circuit boards.

In one or more embodiments, the conferencing system terminal device 101 includes one or more processors 603. In one embodiment, the one or more processors 603 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the conferencing system terminal device 101. Each of the application processor and the auxiliary processor(s) can be configured to process and execute executable software code to perform the various functions of the conferencing system terminal device 101. A storage device, such as memory 604, can optionally store the executable software code used by the one or more processors 603 during operation.

The conferencing system terminal device 101 also includes a communication device 605 that can be configured for wired or wireless communication with one or more other devices or networks. The networks can include a wide area network, a local area network, and/or personal area network. The communication device 605 may also utilize wireless technology for communication, such as, but are not limited to, peer-to-peer or ad hoc communications such as HomeRF, Bluetooth and IEEE 802.11, and other forms of wireless communication such as infrared technology. The communication device 605 can include wireless communication circuitry, one of a receiver, a transmitter, or transceiver, and one or more antennas.

In one embodiment, the one or more processors 603 can be responsible for performing the primary functions of the conferencing system terminal device 101. For example, in one embodiment the one or more processors 603 comprise one or more circuits operable with one or more user interface devices, which can include the display 601, to engage in videoconferences by transmitting, receiving, and presenting images, video, or other presentation information. The executable software code used by the one or more processors 603, including that associated with a videoconference application 606, can be configured as one or more modules 607 that are operable with the one or more processors 603. Such modules 607 can store instructions, control algorithms, logic steps, and so forth.

In one embodiment, the one or more processors 603 are responsible for running the operating system environment of the conferencing system terminal device 101. The operating system environment can include a kernel and one or more drivers, and an application service layer, and an application layer. The operating system environment can be configured as executable code operating on one or more processors or control circuits of the conferencing system terminal device 101.

The application layer can be responsible for executing application service modules. The application service modules may support one or more applications or “apps,” such as the videoconference application 606. The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the one or more processors 603 may generate commands or execute control operations based upon user input received at the user interface 602. Moreover, the one or more processors 603 may process the received information alone or in combination with other data, such as the information stored in the memory 604.

The conferencing system terminal device 101 can include one or more sensors 608. The one or more sensors 608 may include a microphone, an earpiece speaker, and/or a second loudspeaker. The one or more other sensors 608 may also include touch actuator selection sensors, proximity sensors, a touch pad sensor, a touch screen sensor, a capacitive touch sensor, and one or more switches. Touch sensors may be used to indicate whether any of the user actuation targets present on the display 601, including the user actuation target (514) facilitating the return of the application portal facilitating a videoconference to operation as a foreground application described above, are being actuated. The other sensors 608 can also include audio sensors and video sensors (such as a camera).

Other components 609 operable with the one or more processors 603 can include output components such as video outputs, audio outputs, and/or mechanical outputs. Examples of output components include audio outputs such as speaker port, earpiece speaker, or other alarms and/or buzzers and/or a mechanical output component such as vibrating or motion-based mechanisms. Still other components will be obvious to those of ordinary skill in the art having the benefit of this disclosure.

The other components 609 can also include an audio input/processor. The audio input/processor can include hardware, executable code, and speech monitor executable code in one embodiment. The audio input/processor can include, stored in memory 604, basic speech models, trained speech models, or other modules that are used by the audio input/processor to receive and identify voice commands that are received with audio input captured by an audio input/processor, one example of which is a microphone of the one or more sensors 608. In one embodiment, the audio input/processor can include a voice recognition engine. Regardless of the specific implementation utilized in the various embodiments, the audio input/processor can access various speech models to identify speech commands in one or more embodiments.

To capture video during a videoconference, in one or more embodiments the conferencing system terminal device 101 includes an imager 610 or another image capture device. The conferencing system terminal device 101 can optionally include a depth imager as well.

In one embodiment, the imager 610 comprises a two-dimensional imager configured to receive at least one image of a person within an environment of the conferencing system terminal device 101. In one embodiment, the imager 610 comprises a two-dimensional RGB imager. In another embodiment, the imager 610 comprises an infrared imager. Other types of imagers suitable for use as the imager 610 of the conferencing system terminal device 101 will be obvious to those of ordinary skill in the art having the benefit of this disclosure.

In one or more embodiments, the conferencing system terminal device 101 includes a prompt presentation engine 611 configured to present notifications on the display 601 when videoconferences facilitated by the videoconference application 606 are ending or have ended. In one or more embodiments, the prompt presentation engine 611 can perform other operations as well, examples of which include facilitating a return of an application portal of the videoconference application 606 to operating in the foreground when either another application different from the videoconference application 606 is operating as a foreground application or when the other application is operating as the foreground application in an immersive mode of operation. The prompt presentation engine 611 can also determine an area amount of the display 601 required to present a prompt and determine locations and placements for the prompt when presented on the display 601.

In one or more embodiments, the conferencing system terminal device 101 also includes a videoconference cessation monitoring engine 612. In one or more embodiments, the prompt presentation engine 611 and/or videoconference cessation monitoring engine 612 is operable with the one or more processors 603. In some embodiments, the one or more processors 603 can control the prompt presentation engine 611 and/or videoconference cessation monitoring engine 612. In other embodiments, the prompt presentation engine 611 and/or videoconference cessation monitoring engine 612 can operate independently, sensing contextual information from the one or more sensors 608 and/or receiving or identifying contextual information from remote servers and electronic devices using the communication device 605 to the one or more processors 603. The prompt presentation engine 611 and/or videoconference cessation monitoring engine 612 can receive data from the various sensors 608. In one or more embodiments, the one or more processors 603 are configured to perform the operations of the prompt presentation engine 611 and/or videoconference cessation monitoring engine 612.

In one or more embodiments, the videoconference cessation monitoring engine 612 is configured to identify that a videoconference with which the conferencing system terminal device 101 is engaged is ending or has ended. Illustrating by example, the videoconference cessation monitoring engine 612 can identify that the videoconference has ended when all remote electronic devices engaged in the videoconference have disengaged from the videoconference.

In other embodiments, the videoconference cessation monitoring engine 612 can identify that the videoconference has ended by detecting audio signals comprising phrases indicative of videoconference cessation, examples of which include “bye,” “thank you,” and/or “great call.” The videoconference cessation monitoring engine 612 can identify the videoconference has ended by detecting text in a chat window of the application portal of the videoconference application 606 when it comprises phrases indicative of videoconference cessation. In one or more embodiments, the videoconference cessation monitoring engine 612 can determine the videoconference has ended when there is an absence of audio signals from participants of the videoconference for at least a predefined duration. In still other embodiments, the videoconference cessation monitoring engine 612 can determine the videoconference has ended by detecting the absence of the audio signals from the participants of the videoconference for at least the predefined duration occurring after a scheduled adjournment time of the videoconference.

The videoconference cessation monitoring engine 612 can perform other operations as well. In one or more embodiments, the videoconference cessation monitoring engine 612 can determine that an application portal associated with the videoconference application 606 is still operational after the videoconference has ended. Accordingly, this allows the prompt presentation engine 611 to present a prompt when both the videoconference has ended, and the application portal associated with the videoconference application 606 is still operational.

In other embodiments, the videoconference cessation monitoring engine 612 can determine that the application portal associated with the videoconference application 606 is operating as a background application while another application portal associated with another application is operating as a foreground application. This allows the prompt presentation engine 611 to present the prompt only when the videoconference has ended, the application portal associated with the videoconference application 606 is still operational, and the application portal associated with the videoconference application 606 is operating as the background application while the other application associated with the other application is operating as the foreground application.

In other embodiments, the videoconference cessation monitoring engine 612 can determine whether the conferencing system terminal device 101 is operating in the immersive mode of operation. This allows the prompt presentation engine 611 to present the prompt only when the videoconference has ended, the application portal associated with the videoconference application 606 is still operational and the conferencing system terminal device 101 is operating in the immersive mode of operation.

As noted above, the prompt presented by the prompt presentation engine 611 can also facilitate a return of the application portal associated with the videoconference application 606 to again become the foreground application. Illustrating by example, the prompt presentation engine 611 can automatically return the application portal associated with the videoconference application 606 to the foreground so as to become the foreground application again in addition to presenting the prompt. In one or more embodiments, these steps occur concurrently.

It is to be understood that FIG. 6 is provided for illustrative purposes only and for illustrating components of one conferencing system terminal device 101 in accordance with embodiments of the disclosure and is not intended to be a complete schematic diagram of the various components required for an electronic device. Therefore, other conferencing system terminal devices in accordance with embodiments of the disclosure may include various other components not shown in FIG. 6 or may include a combination of two or more components or a division of a particular component into two or more separate components, and still be within the scope of the present disclosure.

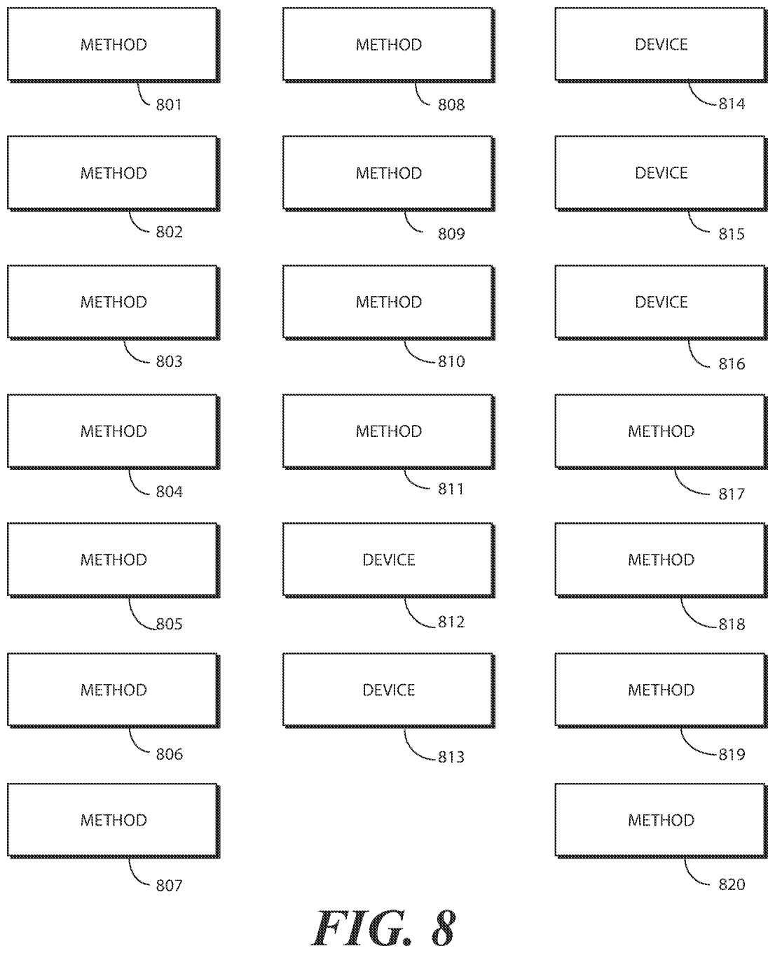

Turning now to FIG. 7, illustrated therein is one explanatory video conferencing system server complex 106 configured in accordance with one or more embodiments of the disclosure. An illustrative schematic block diagram 700 is also shown in FIG. 8.

As with the block diagram schematic (600) of FIG. 6, it is to be understood that the schematic block diagram 700 of FIG. 7 is provided for illustrative purposes only and for illustrating components of one explanatory server complex 106 configured in accordance with one or more embodiments of the disclosure. Accordingly, the components shown in either FIG. 6 or FIG. 7 are not intended to be complete schematic diagrams of the various components required for a particular device, as other devices configured in accordance with embodiments of the disclosure may include various other components not shown in FIG. 6 or FIG. 7. Alternatively, other server complexes or conferencing system terminal devices configured in accordance with embodiments of the disclosure or may include a combination of two or more components or a division of a particular component into two or more separate components, and still be within the scope of the present disclosure.

In one or more embodiments the conferencing system server complex 106 can be configured with performing processor-intensive methods, operations, steps, functions, or procedures associated with the presentation of prompts when a videoconference is ending or has ended, and a user has “checked out.” Illustrating by example, the conferencing system server complex 106 can be configured to receive one or more images in a video feed of a videoconference across a network 105.

A prompt presentation engine 703 can the present notifications in the video feed when videoconferences facilitated by the conferencing system server complex 106 are ending or have ended. In one or more embodiments, the prompt presentation engine 703 can perform other operations as well, examples of which include facilitating a return of an application portal facilitating the videoconference to operation in the foreground.

In one or more embodiments, the conferencing system server complex 106 also includes a videoconference cessation monitoring engine 702. In one or more embodiments, the videoconference cessation monitoring engine 702 is configured to identify that a videoconference with which the conferencing system terminal device is engaged is ending or has ended. The videoconference cessation monitoring engine 702 can perform other operations as well, examples of which have been described above.

In one or more embodiments, the conferencing system server complex 106 includes one or more memory devices 706, and one or more user interface devices 707, e.g., a display, a keyboard, a mouse, audio input devices, audio output devices, and alternate visual output devices. The conferencing system server complex 106 also includes the communication device 705. These components can be operatively coupled together such that, for example, the one or more processors 704 are operable with the one or more memory devices 706, the one or more user interface devices 707, the communication device 705, and/or other components 708 of the conferencing system server complex 106 in one or more embodiments.

The one or more processors 704 can include a microprocessor, a group of processing components, one or more ASICs, programmable logic, or other type of processing device. The one or more processors 704 can be configured to process and execute executable software code to perform the various functions of the conferencing system server complex 106.

The one or more memory devices 706 can optionally store the executable software code used by the one or more processors 704 in carrying out the operations of the videoconference system. The one or more memory devices 706 may include either or both of static and dynamic memory components. The one or more memory devices 706 can store both embedded software code and user data.

In one or more embodiments, the one or more processors 704 can define one or more process engines. For instance, the software code stored within the one or more memory devices 706 can embody program instructions and methods to operate the various functions of the conferencing system server complex 106, and also to execute software or firmware applications and modules such as the prompt presentation engine 803, the videoconference cessation monitoring engine 702, and/or the video conferencing engine 709.

Embodiments of the disclosure contemplate that conferencing system terminal devices used in videoconferencing applications can be operable with companion devices in a “ready for” environment. Illustrating by example, a conferencing system terminal device can include a companion device display integration manager. The companion device display integration manager can be used to communicate with a companion electronic device, one example of which is a content presentation companion device.

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments. Thus, the embodiments are shown as labeled boxes.

At 801, a method in a conferencing system terminal device comprises detecting, with one or more processors during a videoconference, a communication device electronically in communication with one or more remote electronic devices engaged in the videoconference. At 801, the method comprises identifying, by the one or more processors, that the videoconference has ended.

At 801, the method comprises determining, by the one or more processors, that an application portal associated with the videoconference is still operational after the videoconference has ended. At 801, the method comprises presenting, by the one or more processors on a user interface of the conferencing system terminal device, a prompt when both the videoconference has ended, and the application portal associated with the videoconference is still operational.

At 802, the method of 801 further comprises also determining, by the one or more processors, that the application portal associated with the videoconference is operating as a background application while another application portal associated with another application is operating as a foreground application. At 803, the presentation of the prompt at 802 occurs only when the videoconference has ended, the application portal associated with the videoconference is still operational, and the application portal associated with the videoconference is operating as the background application while another application portal associated with another application is operating as the foreground application.

At 804, the prompt of 803 facilitates causing the application portal associated with the videoconference to again become the foreground application. At 805, the method of 803 further comprises automatically returning, by the one or more processors, the application portal associated with the videoconference to again become the foreground application in addition to the presenting the prompt.

At 806, the identification of 801 that the videoconference has ended comprises detecting audio signals comprising phrases indicative of videoconference cessation. At 807, the phrases indicative of videoconference cessation of 806 comprise one or more of “bye,” “thank you,” and/or “great call.”

At 808, the identification of 801 that the videoconference has ended comprises detecting text in a chat window of the application portal comprising phrases indicative of videoconference cessation. At 809, the identification of 801 that the videoconference has ended comprises detecting an absence of audio signals from participants of the videoconference for at least a predefined duration. At 810, the detecting the absence of the audio signals from participants of the videoconference for the at least a predefined duration at 809 occurs after a scheduled adjournment time of the videoconference.

At 811, the method of 801 further comprises determining that the conferencing system terminal device is operating in an immersive mode of operation while the communication device is electronically in communication with the one or more remote electronic devices engaged in the videoconference. At 811, the presenting of the prompt occurs only when the videoconference has ended, the application portal associated with the videoconference is still operational, and the conferencing system terminal device is operating in the immersive mode of operation.

At 812, a conferencing system terminal device comprises a communication device in communication with one or more remote electronic devices during a videoconference. At 812, the conferencing system terminal device comprises a user interface and one or more processors operable with the communication device and the user interface.

At 812, the one or more processors determine that the videoconference has ended while a videoconferencing application is operating on the one or more processors to present an application portal facilitating the videoconference on the user interface. At 812 the one or more processors indicate that the videoconference has ended while the videoconferencing application is operating on the one or more processors after the videoconference has ended.

At 813, the prompt of 812 comprises an audible prompt. At 814, the one or more processors of 812 present the prompt indicating that the videoconference has ended only when the application portal of the videoconferencing application is operating in an immersive mode of operation.

At 815, the one or more processors of 812 present the prompt indicating that the videoconference has ended only when another application portal that is different from the application portal facilitating the videoconference is operating as a foreground application. At 816, the conferencing system terminal device of 815 further comprise causing the application portal facilitating the videoconference to become the foreground application concurrently with presentation of the prompt.

At 817, a method in a conferencing system terminal device comprises detecting, with one or more processors during a videoconference, a communication device electronically in communication with one or more remote electronic devices engaged in the videoconference while an application portal facilitating the videoconference operating as a background application and another application portal that is different from the application portal facilitating the videoconference is operating in an immersive mode of operation as a foreground application. At 817, the method comprises identifying, by the one or more processors, that the videoconference has ended.

At 817, the method comprises presenting, by the one or more processors, a prompt at a user interface indicating that the videoconference has ended. At 817, the prompt facilitates return of the application portal facilitating the videoconference to operating as the foreground application.

At 818, the application portal of 817 facilitating the videoconference is inaccessible at the user interface when the other application is operating in the immersive mode of operation as the foreground application. At 819, the identification of 818 that the videoconference has ended occurs when all of the one or more remote electronic devices disengage from the videoconference. At 820, the presenting of 817 of the prompt occurs only when the application portal facilitating the videoconference is still operational after the videoconference has ended.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in a conferencing system terminal device, the method comprising:
detecting, with one or more processors during a videoconference, a communication device electronically in communication with one or more remote electronic devices engaged in the videoconference;
identifying, by the one or more processors, that the videoconference has ended;
determining, by the one or more processors, that an application portal associated with the videoconference is still operational after the videoconference has ended; and
presenting, by the one or more processors on a user interface of the conferencing system terminal device, a prompt when both the videoconference has ended, and the application portal associated with the videoconference is still operational.

2. The method of claim 1, further comprising also determining, by the one or more processors, that the application portal associated with the videoconference is operating as a background application while another application portal associated with another application is operating as a foreground application.

3. The method of claim 2, wherein the presenting of the prompt occurs only when:
the videoconference has ended;
the application portal associated with the videoconference is still operational; and
the application portal associated with the videoconference is operating as the background application while the another application portal associated with the another application is operating as the foreground application.

4. The method of claim 3, wherein the prompt facilitates causing the application portal associated with the videoconference to again become the foreground application.

5. The method of claim 3, further comprising automatically returning, by the one or more processors, the application portal associated with the videoconference to again become the foreground application in addition to the presenting the prompt.

6. The method of claim 1, wherein the identifying that the videoconference has ended comprises detecting audio signals comprising phrases indicative of videoconference cessation.

7. The method of claim 6, wherein the phrases indicative of the videoconference cessation comprise one or more of “bye,” “thank you,” and/or “great call.”

8. The method of claim 1, wherein the identifying that the videoconference has ended comprises detecting text in a chat window of the application portal comprising phrases indicative of videoconference cessation.

9. The method of claim 1, wherein the identifying that the videoconference has ended comprises detecting an absence of audio signals from participants of the videoconference for at least a predefined duration.

10. The method of claim 9, wherein the detecting the absence of the audio signals from participants of the videoconference for the at least a predefined duration occurs after a scheduled adjournment time of the videoconference.

11. The method of claim 1, further comprising determining that the conferencing system terminal device is operating in an immersive mode of operation while the communication device is electronically in communication with the one or more remote electronic devices engaged in the videoconference, wherein the presenting of the prompt occurs only when:
the videoconference has ended;
the application portal associated with the videoconference is still operational; and
the conferencing system terminal device is operating in the immersive mode of operation.

12. A conferencing system terminal device, comprising:
a communication device in communication with one or more remote electronic devices during a videoconference;
a user interface; and
one or more processors operable with the communication device and the user interface;
the one or more processors determining that the videoconference has ended while a videoconferencing application is operating on the one or more processors to present an application portal facilitating the videoconference on the user interface, and presenting a prompt indicating that the videoconference has ended while the videoconferencing application is operating on the one or more processors after the videoconference has ended.

13. The conferencing system terminal device of claim 12, wherein the prompt comprises an audible prompt.

14. The conferencing system terminal device of claim 12, wherein the one or more processors present the prompt indicating that the videoconference has ended only when the application portal of the videoconferencing application is operating in an immersive mode of operation.

15. The conferencing system terminal device of claim 12, wherein the one or more processors present the prompt indicating that the videoconference has ended only when another application portal that is different from the application portal facilitating the videoconference is operating as a foreground application.

16. The conferencing system terminal device of claim 15, further comprising causing the application portal facilitating the videoconference to become the foreground application concurrently with presentation of the prompt.

17. A method in a conferencing system terminal device, the method comprising:
detecting, with one or more processors during a videoconference, a communication device electronically in communication with one or more remote electronic devices engaged in the videoconference while an application portal facilitating the videoconference operating as a background application and another application portal that is different from the application portal facilitating the videoconference is operating in an immersive mode of operation as a foreground application;
identifying, by the one or more processors, that the videoconference has ended; and
presenting, by the one or more processors, a prompt at a user interface indicating that the videoconference has ended;
wherein the prompt facilitates return of the application portal facilitating the videoconference to operating as the foreground application.

18. The method of claim 17, wherein the application portal facilitating the videoconference is inaccessible at the user interface when the another application is operating in the immersive mode of operation as the foreground application.

19. The method of claim 18, wherein the identifying that the videoconference has ended occurs when all of the one or more remote electronic devices disengage from the videoconference.

20. The method of claim 17, wherein the presenting the prompt occurs only when the application portal facilitating the videoconference is still operational after the videoconference has ended.
